(19) United States
(12) Patent Application Publication
(10) Pub. No.: US 2023/0233886 A1
(43) Pub. Date: Jul. 27, 2023

(54) RESPIRATOR

(71) Applicant: FORGED AIR LTD., Kitchener (CA)

(72) Inventors: Mark Hacking, Waterloo (CA); Paul Beechey, London (CA); Sam Rich, Kitchener (CA); Matt Hexemer, Minesing (CA); Borys Chylinski, Collingwood (CA); James Stonehewer, Burlington (CA)

(73) Assignee: FORGED AIR LTD., Kitchener (CA)

(21) Appl. No.: 18/158,927

(22) Filed: Jan. 24, 2023

Related U.S. Application Data
(60) Provisional application No. 63/302,368, filed on Jan. 24, 2022.

(51) Int. Cl. A62B 18/08; A62B 18/02; A62B 23/02; A62B 9/00; A62B 9/04; A41D 13/11

(52) U.S. Cl. CPC A62B 18/08; A62B 18/025; A62B 23/025; A62B 18/088; A62B 9/006; A62B 9/04; A62B 18/084; A62B 18/082; A41D 13/1184

(57) ABSTRACT

A respirator for protecting against airborne particles includes a face gasket for providing a seal around the mouth and nose of a user, a frame attached to the gasket, a filter compression ring removably attached to the frame and a filter for filtering airborne particles from air. The filter is positioned between the frame and the filter compression ring. An eye protection accessory is attachable to the gasket. The respirator additionally includes a safety module that includes an air pressure sensor that can monitor the air pressure in the space bounded by the user's face and the filter. A processor analyzes the air pressure measurements obtained by the air pressure sensor and a vibration motor or a visual indicator. The processor can trigger the vibration motor and the visual indicator when the air pressure exceeds a predetermined threshold.

### CROSS-REFERENCE TO RELATED APPLICATIONS

This application claims the benefit of U.S. Provisional Patent Application No. 63/302,368 filed on Jan. 24, 2022, the entire content of which is hereby incorporated by reference.

### FIELD

The embodiments described herein generally relate to filtering air and in particular, to respirators for protecting a wearer against airborne particles.

### BACKGROUND

The following paragraphs are provided by way of background to the present disclosure. They are not, however an admission that anything discussed below is part of the prior art or part of the common general knowledge of a person skilled in the art.

Disposable masks and reusable respirators are commonly used in various settings, such as medical settings, construction sites, recreational shooting ranges, and manufacturing plants, to protect the wearer against inhaling potentially harmful particles. These masks and respirators typically cover the wearer's nose and mouth and include a filter to filter the air inhaled and exhaled by the wearer, preventing the wearer from inhaling potentially harmful particles and from releasing potentially contaminated air into the environment.

Disposable masks due to their design, however, typically provide a poor seal, which can pose dangers to the wearer or to individuals located nearby. Reusable respirators provide a better seal but due to their bulky design can be uncomfortable for individuals who require eyeglasses and interfere with communication between respirator wearers. The ability to communicate when wearing a respirator or mask can be important, particularly in medical settings.

In settings that require masks or respirators, eye protection is often also required. Typically, eye protection is worn by the user similar to traditional eyeglasses, or secured to the user's face via a strap wrapping around the user's head. For individuals who require eyeglasses however, traditional eye protection may be uncomfortable or impractical.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

The various embodiments described herein generally relate to respirators for protecting a wearer against airborne particles.

In a broad aspect, a respirator is disclosed herein. The respirator can include a face gasket for providing a seal around a mouth and a nose of a wearer; a frame attached to the face gasket; a filter compression ring removably attached to the frame; and a filter for filtering airborne particles from air, wherein the filter is positioned between the frame and the filter compression ring.

In some embodiments, the filter is adapted to cover a surface of the frame opposite the face gasket.

In some embodiments, the frame comprises a filter support for supporting the filter over the frame and for maintaining a shape of the filter.

In some embodiments, the filter is removably attached to the filter compression ring.

In some embodiments, the filter is fused to the frame.

In some embodiments, the filter is ultrasonically fused to the frame.

In some embodiments, the respirator comprises a safety module. The safety module comprises: one or more air pressure sensors for obtaining air pressure measurements in a space bounded by the nose and the mouth of the wearer and the filter; a processor in communication with the one or more air pressure sensors, the processor configured to analyze the air pressure measurements; and at least one of a vibration motor and a status indicator.

In some embodiments, the processor is further configured to: determine a baseline air pressure; determine a current air pressure; and when the current air pressure exceeds the baseline air pressure by a predetermined threshold, trigger the at least one of the vibration motor or the visual indicator to generate an alert.

In some embodiments, the safety module further comprises a motion sensor coupled to the processor, wherein the processor is configured to analyze motion measurements obtained by the motion sensor.

In some embodiments, the safety module further comprises a communication interface configured to transmit the air pressure measurements to an external device for analysis.

In some embodiments, the face gasket is configured to be positioned to terminate at a nose bridge of the wearer.

In some embodiments, the respirator further comprises: a first strap removably attached to the frame and a second strap removably attached to the frame, the first strap and second strap configured to secure the respirator to the wearer, wherein the first strap is configured to wrap behind a head of the wearer and the second strap is configured to wrap behind a neck of the wearer.

In some embodiments, a length of the first strap and a length of the second strap are adjustable.

In some embodiments, the second strap comprises a first portion and a second portion, and wherein the first portion is configured to attach to the second portion via a fastener.

In some embodiments, the first strap comprises a skull cap configured to be positioned on a crown of the head of the user.

In another aspect, another respirator is disclosed herein. The respirator can include a face gasket for providing a seal around a mouth and a nose of a wearer; a frame attached to the face gasket; a filter compression ring removably attached to the frame; a filter for filtering airborne particles from air, wherein the filter is positioned between the filter compression ring and the frame and generally perpendicular to the mouth of the wearer; and an eye protection removably attached to an outside surface of the face gasket and extending above the frame.

In some embodiments, the eye protection is configured to wrap around the user's face.

In some embodiments, the eye protection includes a lip substantially perpendicular to the nose of the wearer.

In some embodiments, the eye protection comprises a first branch, a second branch and a lens, wherein the first branch and the second branch are adapted to wrap around the outside surface of the face gasket and wherein the lens extends above the frame.

In some embodiments, an underside of the lens comprises an aperture, the frame comprises a peg and the peg is adapted to couple to the aperture to attach the lens to the frame.

In some embodiments, the filter is fused to the frame.

In some embodiments, the filter is ultrasonically fused to the frame.

In some embodiments, the respirator comprises a safety module. The safety module comprises: one or more air pressure sensors for obtaining air pressure measurements in a space bounded by the nose and the mouth of the wearer and the filter; a processor in communication with the one or more air pressure sensors, the processor configured to analyze the air pressure measurements; and at least one of a vibration motor and a status indicator.

In some embodiments, the processor is further configured to: determine a baseline air pressure; determine a current air pressure; and when the current air pressure exceeds the baseline air pressure by a predetermined threshold, trigger the at least one of the vibration motor or the visual indicator to generate an alert.

In some embodiments, the safety module further comprises a motion sensor coupled to the processor, wherein the processor is configured to analyze motion measurements obtained by the motion sensor.

In some embodiments, the safety module further comprises a communication interface configured to transmit the air pressure measurements to an external device for analysis.

In some embodiments, the face gasket is configured to be positioned to terminate at a nose bridge of the wearer.

In some embodiments, the respirator further comprises: a first strap removably attached to the frame and a second strap removably attached to the frame, the first strap and second strap configured to secure the respirator to the wearer, wherein the first strap is configured to wrap behind a head of the wearer and the second strap is configured to wrap behind a neck of the wearer.

In some embodiments, a length of the first strap and a length of the second strap are adjustable.

In some embodiments, the second strap comprises a first portion and a second portion, and wherein the first portion is configured to attach to the second portion via a fastener.

In some embodiments, the first strap comprises a skull cap configured to be positioned on a crown of the head of the user.

In another aspect, another respirator is disclosed herein. The respirator can include a face gasket for providing a seal around a mouth and a nose of a wearer; a frame attached to the face gasket; a filter compression ring removably attached to the frame; a filter for filtering airborne particles from air, wherein the filter is suspended between the filter compression ring and the frame, generally perpendicular to the mouth of the wearer; and a communications module configured to communicate with an external device.

In some embodiments, the communications module can include one or more speakers, a microphone, and a communication interface.

In some embodiments, the communications module comprises: one or more speakers; a microphone; and a communication interface;

In some embodiments, the communications module further comprises: a motion sensor; and a status light.

In some embodiments, the respirator further comprises an eye protection removably attached to an outside surface of the face gasket and extending above the frame.

In some embodiments the respirator can include a strap removably attached to the frame and extending from the frame. The strap can wrap around the user's head. The communications module can be removably mounted on the strap and positioned near the user's ear.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A is a perspective view of an example respirator in accordance with an embodiment;

FIG. 1B is an exploded perspective view of a portion of the example respirator shown in FIG. 1A;

FIG. 1C is a front partially exploded view of the example respirator shown in FIG. 1A;

FIG. 1D is a perspective partially exploded view of the example respirator shown in FIG. 1A;

FIG. 2 shows example face gaskets of the example respirator shown in FIG. 1A;

FIG. 3A is a front perspective view of an example face gasket of the respirator shown in FIG. 1A;

FIG. 3B is a back view of the example face gasket shown in FIG. 3A;

FIG. 3C is a back perspective view of the example face gasket shown in FIG. 3A;

FIG. 4A is a top view and a cross-sectional view of an example face gasket of the example respirator shown in FIG. 1A;

FIG. 4B is a perspective cross-sectional view of an example gasket-frame assembly and an example filter compression ring of the example respirator shown in FIG. 1A prior to assembly;

FIG. 4C is a perspective cross-sectional view of the example gasket-frame assembly and the example filter compression ring of FIG. 4B after assembly;

FIG. 5A is a cross-sectional view of a portion of an example gasket-frame assembly of the example respirator shown in FIG. 1A;

FIG. 5B is a cross-sectional view of a portion of the example gasket-frame assembly of FIG. 5A as worn by a wearer;

FIG. 6A is a front view of an example frame of the example respirator shown in FIG. 1A;

FIG. 6B is a back view of the example frame shown in FIG. 6A;

FIG. 6C is a back perspective view of the example frame shown in FIG. 6A;

FIG. 6D is a front perspective view of the example frame shown in FIG. 6A;

FIG. 7 is a front view of an example filter of the example respirator shown in FIG. 1A;

FIG. 8A is a front perspective view of an example filter compression ring of the example respirator shown in FIG. 1A;

FIG. 8B is a back perspective view of the example filter compression ring shown in FIG. 7A;

FIG. 8C is a front view of the example filter compression ring shown in FIG. 7A;

FIG. 8D is a back view of the example filter compression ring shown in FIG. 7A;

FIG. 8E is a cross-sectional view and a close-up view of the example filter compression ring shown in FIG. 7A

FIG. 9 is schematic diagram of a method of installing a filter in the example respirator shown in FIG. 1A;

FIG. 10 is a cross-sectional view of a close-up of the frame, the filter and the compression ring of the example respirator shown in FIG. 1A when assembled;

FIG. 11 is perspective view of a portion of the example respirator shown in FIG. 1A;

FIG. 12A is a top view of an example head strap and skull cap assembly of the example respirator shown in FIG. 1A;

FIG. 12B is a front view of the example head strap shown in FIG. 12A;

FIG. 12C is a back view of the example head strap shown in FIG. 12A;

FIG. 13A is front view of an example neck strap of the example respirator shown in FIG. 1A;

FIG. 13B is a front view of a portion of the example neck strap shown in FIG. 13A,

FIG. 13C is a back view of the portion of the example neck strap shown in FIG. 13A;

FIG. 14A is a perspective view of an example safety module of the example respirator shown in FIG. 1A;

FIG. 14B is a perspective close-up view of an example safety module of the example respirator shown in FIG. 14A;

FIG. 14C is another perspective close-up view of the example safety module shown in FIG. 14A;

FIG. 14D is a bottom view of the example safety module shown in FIG. 14A,

FIG. 15A is a perspective view of another example respirator in accordance with an embodiment;

FIG. 15B is another perspective view of the example respirator shown in FIG. 15A,

FIG. 15C is a partially exploded view of the example respirator shown in FIG. 15A;

FIG. 15D is a partially exploded view of the example respirator shown in FIG. 15A;

FIG. 15E is a back perspective view of the example respirator shown in FIG. 15A;

FIG. 16A is a front view of an example eye protection of the example respirator shown in FIG. 15A;

FIG. 16B is a side view of the example eye protection shown in FIG. 16A;

FIG. 16C is a bottom perspective view of the eye protection shown in FIG. 16A;

FIG. 16D is a top view of an example frame of the example respirator shown in FIG. 15A;

FIG. 17 is a partial cross-sectional view of the example respirator shown in FIG. 15A,

FIG. 18A is a closeup cross-sectional view of the eye protection and gasket of the example respirator shown in FIG. 15A;

FIG. 18B is a closeup cross-sectional view of the eye protection and gasket shown in FIG. 18A as worn by a wearer;

FIG. 19A is a side view of another example respirator in accordance with an embodiment;

FIG. 19B is a closeup perspective view of the example respirator shown in FIG. 19A;

FIG. 19C is a closeup view of an example communications module of the example respirator shown in FIG. 19A, and

FIG. 20 is a perspective view of another example respirator in accordance with an embodiment.

Further aspects and features of the example embodiments described herein will appear from the following description taken together with the accompanying drawings.

### DETAILED DESCRIPTION OF THE EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more elements are said to be “coupled”, “connected”, “attached”, or “fastened” where the parts are joined or operate together either directly or indirectly (i.e., through one or more intermediate parts), so long as a link occurs. As used herein and in the claims, two or more elements are said to be “directly coupled”, “directly connected”, “directly attached”, or “directly fastened” where the element are connected in physical contact with each other. None of the terms “coupled”, “connected”, “attached”, and “fastened” distinguish the manner in which two or more elements are joined together.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “wearer” and “user” are used interchangeably unless expressly specified otherwise.

Masks and respirators can be used in various settings that require air to be filtered and can provide protection against harmful particles. However, traditional disposable masks, to accommodate various face sizes, are typically shaped in a way that provides a poor seal around the user's nose, creating a risk of exposure to harmful particles and causing fogging if the mask is worn with eyeglasses. Additionally, disposable masks are typically secured around the user's nose and mouth region using ear loops, which cannot be adjusted, leading to gaps around the mask if the ear loops are too large, or causing discomfort if the ear loops are too small. Further, ear loops can interfere with eyeglasses, which also rest on the wearer's ears.

Traditional reusable respirators on the other hand, to accommodate a variety of face and nose shapes, typically have a bulky nose area, However, this bulky nose area typically extends beyond the wearer's nose bridge, forcing wearers who require eyeglasses to rest their eyeglasses above their nose bridge, causing the focal accuracy of their eyeglasses to be disrupted. Traditional respirators also typically include a bulky, generally pyramid-shaped housing or frame, and small filters relative to the housing or small openings in the housing, forcing the air exhaled by the user to pass through a small opening to be filtered by the filter and the inhaled air to pass through a small opening once it is filtered. Traditional respirator filters are also typically located on each side of the frame and the portion of the respirator in front of the wearer's mouth is typically a dense frame, making communication difficult. In medical settings, poor communication may be dangerous.

In settings that require the use of a respirator, eye protection is often also required. Eye protection is typically provided by protective goggles, which are typically not designed for eyeglass wearers and can press against the wearer's eyeglasses, causing discomfort. Other types of eye protection include protective glasses, which may be worn like traditional eyeglasses and rest over the user's ears, causing additional weight to be added over the user's ears, which can lead to discomfort or can lead to the protective glasses to fall off the user's face.

Embodiments described herein provide respirators adapted to be worn with eyeglasses that can be secured to a user's face, provide a seal and filter particles from the air inhaled and exhaled by the wearer. The embodiments described herein also improve breathability and audibility when compared to traditional respirators and masks. The embodiments described herein can also include a safety module that can alert the wearer of breaches in the seal formed around the wearer's nose and mouth.

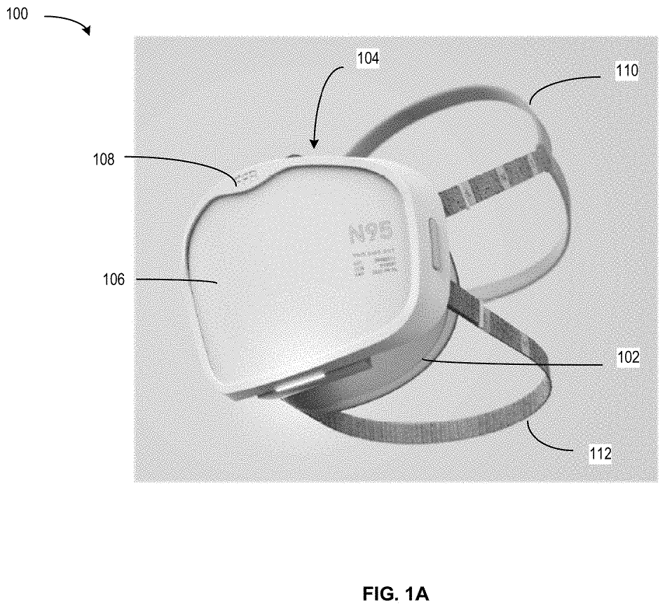

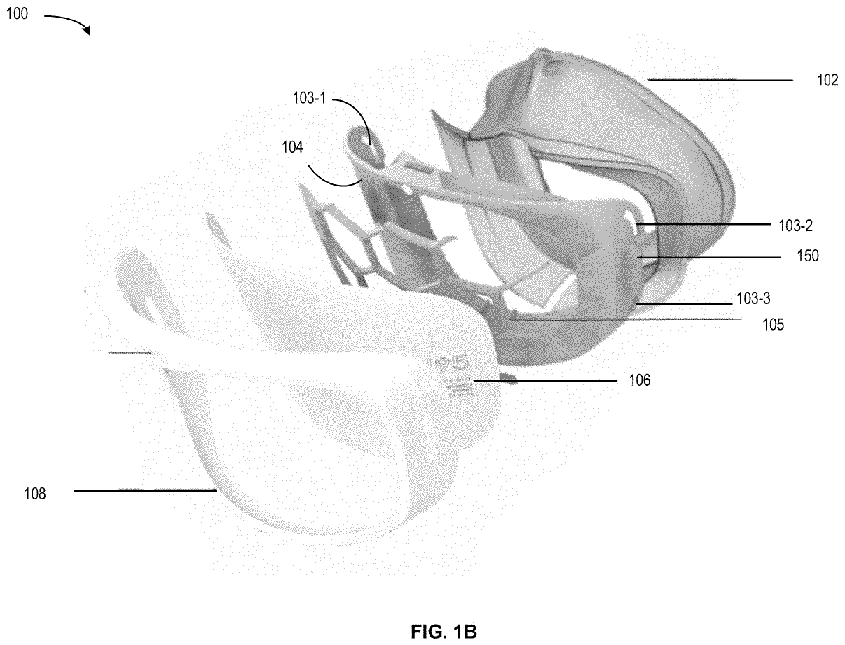

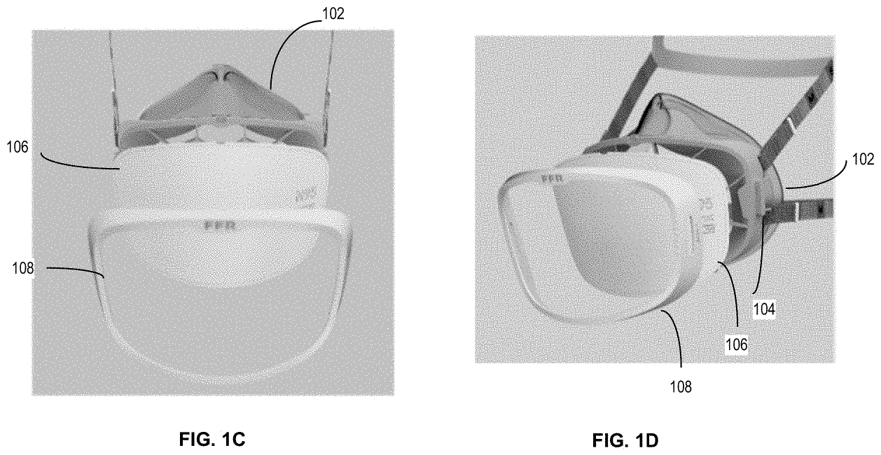

Referring first to FIGS. 1A-1D, there is shown an example respirator 100 adapted to protect the wearer by filtering airborne particles. The respirator 100 can include a face gasket 102, a frame 104, a filter 106 and a filter compression ring 108. The respirator 100 can be secured to the wearer's head via a head strap 110 and a neck strap 112.

The respirator 100 may be used in medical settings, for example, by paramedics and dentists, in recreational settings, for example, in shooting ranges, in manufacturing environments and in any other setting that may require filtering of airborne particles.

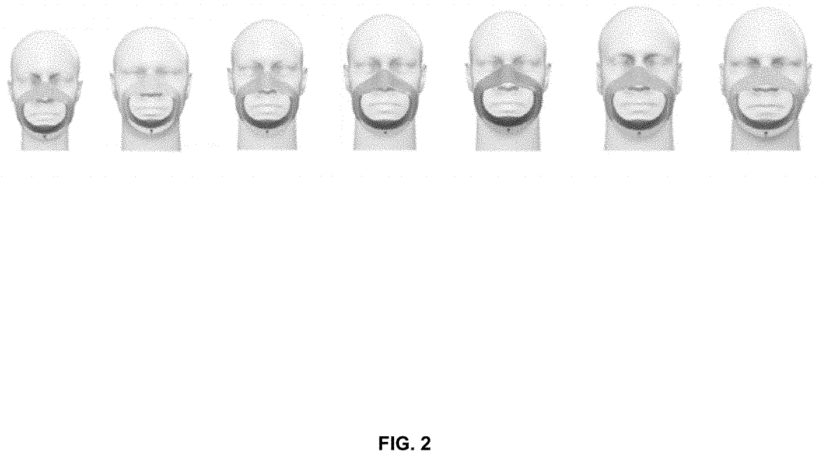

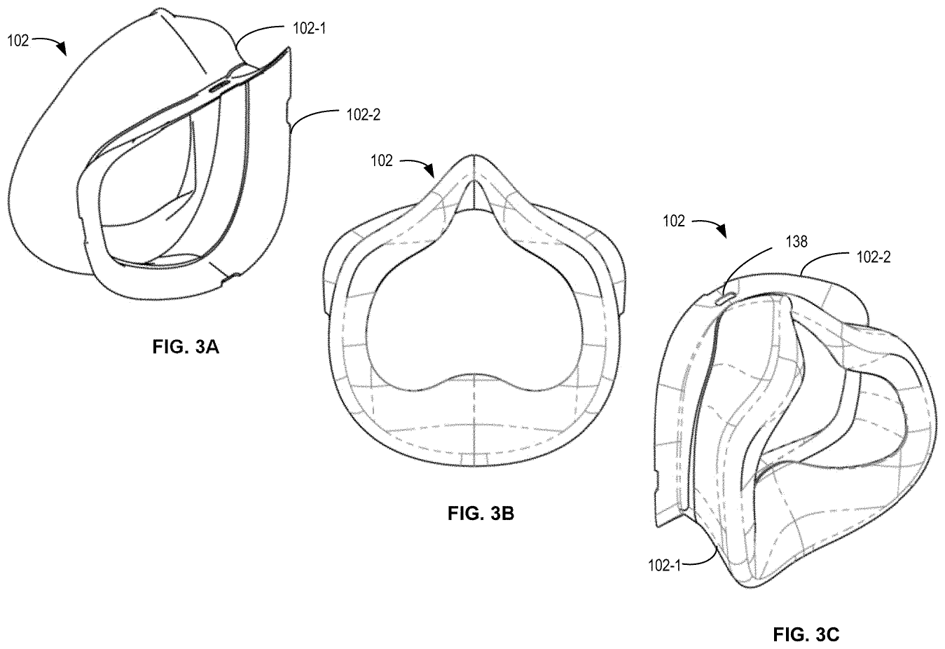

Referring to FIGS. 3A-3C, there is shown an example gasket 102 that can be used in the respirator 100. As shown, the gasket 102 can include a first portion 102-1 shaped to conform to the wearer's face and a second portion 102-2 shaped substantially like the frame 104 to extend into the frame 104. The first portion 102-1 may be provided in various sizes to adapt to the size and shape of the wearer's face, as shown in FIG. 2. The second portion may have a fixed size to attach to the frame 104. In at least one embodiment, the gasket 102 may be interchangeable to accommodate a variety of face and nose shapes. For example, the first portion 102-1 of the gasket may be provided in various sizes to provide a better fit.

The face gasket 102 is configured to terminate at or below the nose bridge of the wearer, which can allow the wearer to wear eyeglasses without interference, unlike traditional respirators or masks, while providing a seal around the wearer's mouth and nose. To increase stability, the gasket 102 may be shaped to extend over a middle portion of the cheeks of the wearer as shown in FIG. 2, which shows multiple face gaskets adapted to the user's face size.

The gasket may be made of a flexible material allowing the gasket to conform to the user's face. For example, the face gasket 102 may be a medical grade silicone gasket, though it will be appreciated that the face gasket 102 can be made of any type of flexible material suitable for the environment in which the respirator 100 is used.

The gasket 102 may be attached to the frame 104 of the respirator 100. For example, the gasket 102 may be attached to the frame such that a portion of the gasket 102 extends into the frame 104. For example, a portion of the exterior of the gasket 102 can be partially surrounded by the frame 104. Similarly, an inner portion of the frame 104 may extend into the gasket 102 when the gasket 102 is attached to the frame 104. The gasket 102 may be permanently affixed to the frame 104 or may be removably attached to the frame 104.

As shown in FIG. 3C, the gasket 102 can include an opening 138 shaped for securing the filter compression ring 108 to the frame-gasket assembly and/or for securing the gasket 102 to the frame 104, as will be described in further detail below.

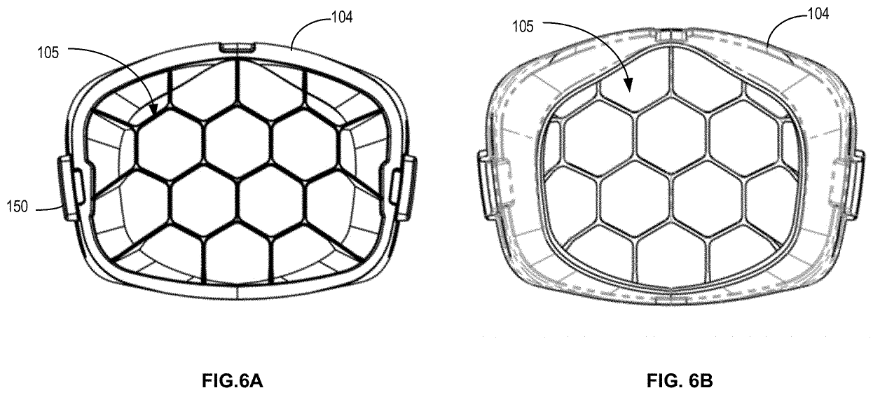

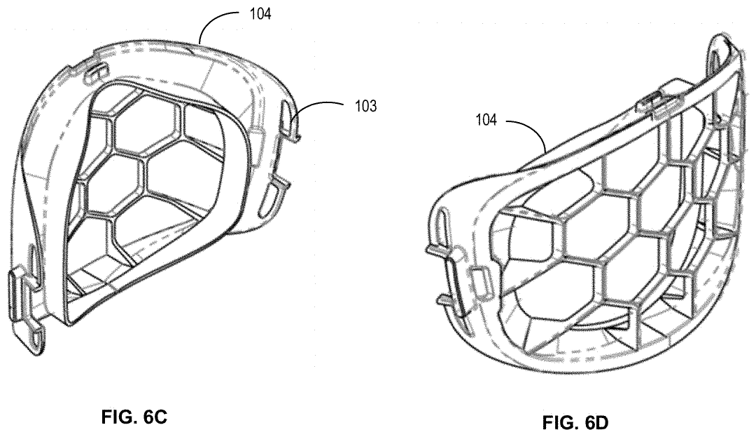

As shown in FIGS. 1A-1D and FIGS. 6A-6D, the respirator 100 can include a frame 104. The frame may be a rigid frame, for example, a rigid polycarbonate frame.

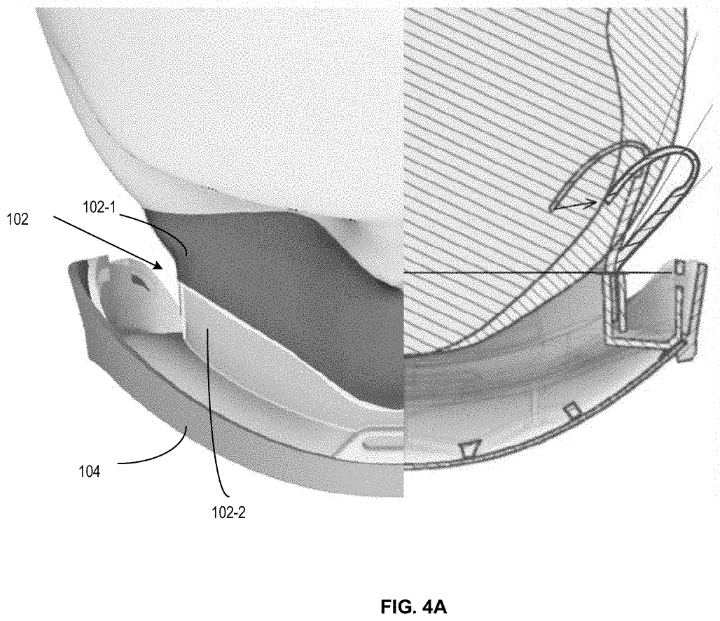

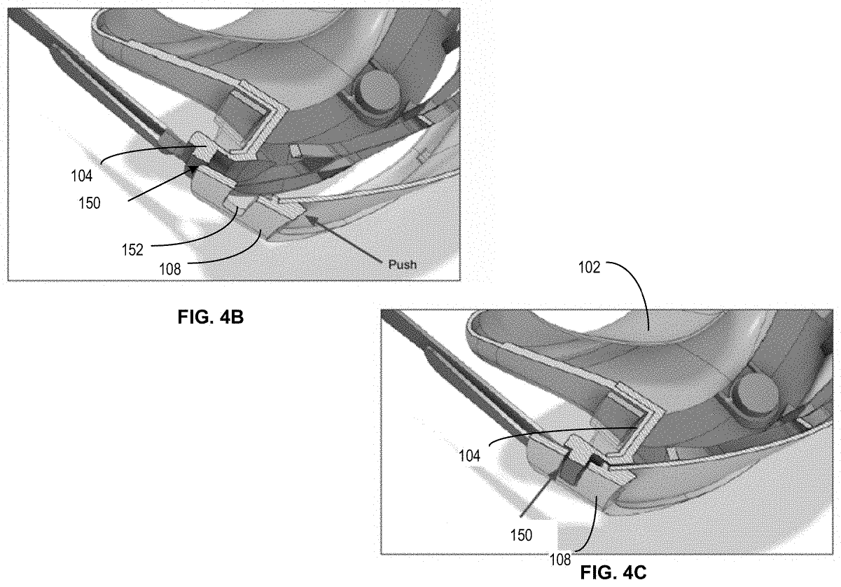

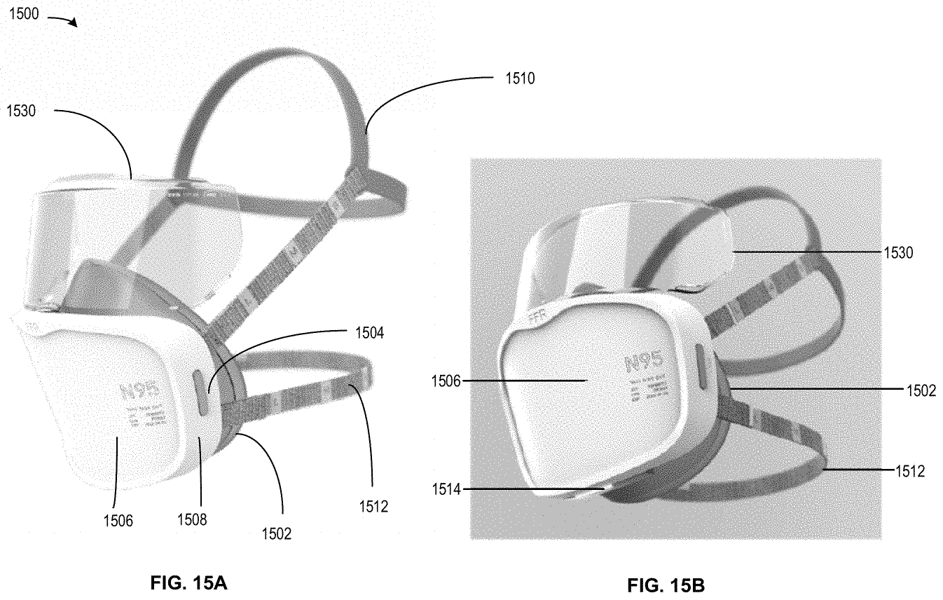

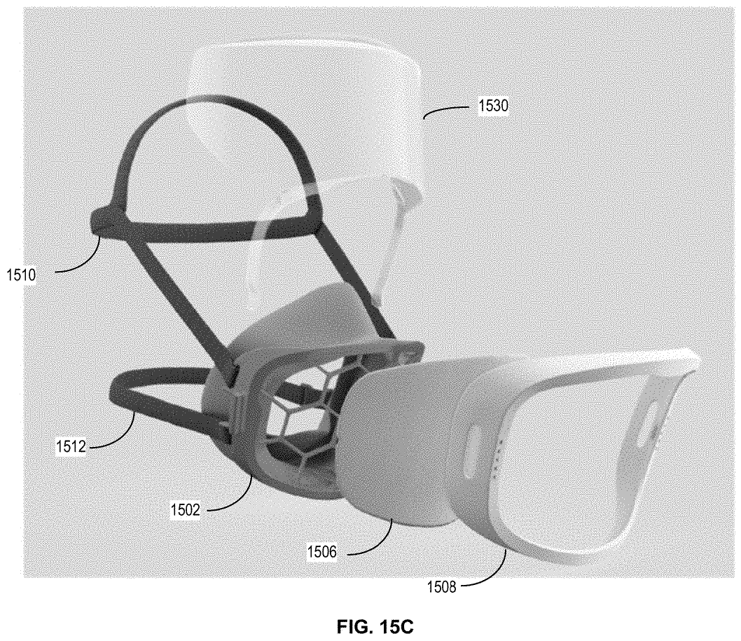

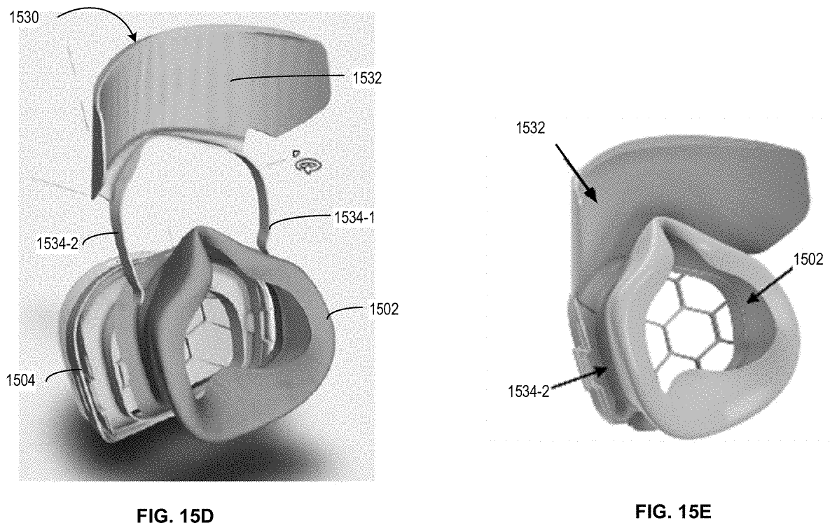

The frame 104 may be designed to align with an inner surface of the gasket 102 such that a portion of the frame extends into the gasket. For example, an exterior surface of an inner portion of the frame 104 can be surrounded by the gasket 102 similar to the respirator of FIGS. 15A-15E and as shown in FIGS. 4B-4C. Additionally, an interior surface of an outer portion of the frame 104 can surround the gasket 102, such that the gasket 102 is securely attached to the frame 104.

In at least some embodiments, the frame may include a slit 103-1, 103-2 on each upper lateral portion of the frame, to accommodate a strap. In at least some embodiments, the frame may include a second pair of slits 103-3 (second slit not shown) on a lower lateral portion of the frame, to accommodate a second strap.

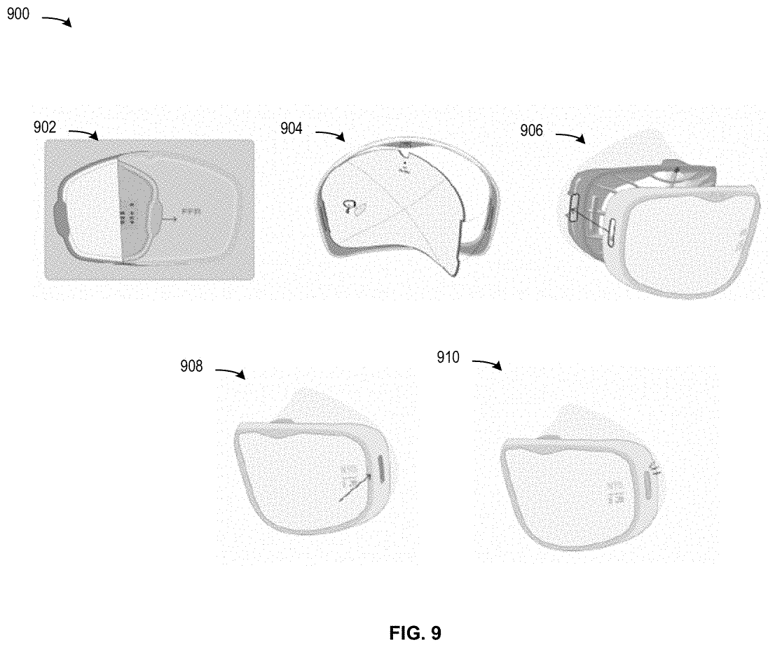

The 104 may also include one or more protruding pegs 150 on the exterior of the lateral portion of the frame, for example, on each lateral side of the frame 104 that can allow the filter compression ring to be attached to the frame as will be described in further detail with reference to FIG. 9.

Referring to FIG. 4A, there is shown the frame 104 attached to the gasket 102. The gasket 102 can include a first portion 102-1 that can provide a seal around the wearer's face and mouth and second portion 102-2 that can attach to the frame, as described above with reference to FIGS. 3A-3C. The second portion 102-2 may be permanently attached to the frame 104 during the manufacturing process or may be removably attached to the frame 104.

Referring now to FIGS. 4B-4C, there is shown a closeup view of the gasket 102 and frame 104, when assembled and the filter compression ring 108. As shown, the frame 104 can include peg(s) 150 and the compression ring 108 can include aperture(s) 152 adapted to couple with the peg(s) 150. When the filter compression ring 108 and the frame 104 are attached, the peg(s) 150 can fit into the corresponding aperture(s) 152.

As shown in FIG. 1A and FIGS. 6A-6D, in at least some embodiments, the frame can include a filter support 105 that may be integrated within the frame 104. Alternatively, the filter support may be removably attached to the frame. The filter support 105 can allow the filter 106 to be suspended away from the wearer's face by supporting the filter 106 on the frame 104 and can prevent deformation of the filter 106 (i.e., the filter support can prevent the filter from sagging). The filter support 105 may be a low-density structure that can allow air and sound to pass through while supporting the filter and preventing the filter from deforming. For example, the filter support may have a honeycomb structure as shown.

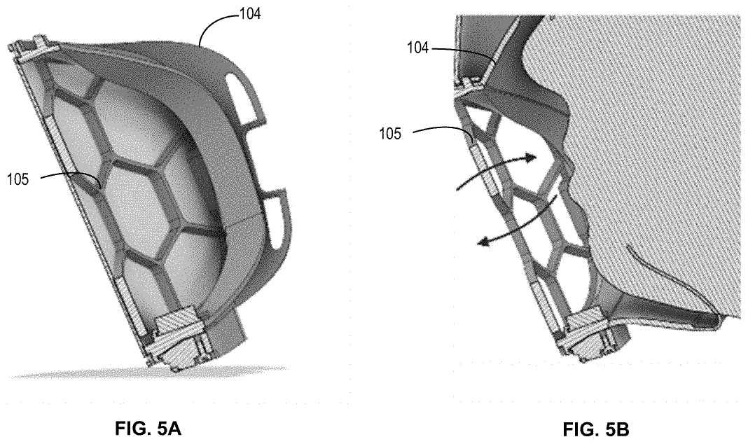

As shown in FIGS. 5A-5B, when compared to traditional masks and respirators, the frame can provide additional spacing between the wearer's nose and mouth and the filter, such that the filter is suspended in front of the wearer's nose and mouth area without contacting with the wearer's nose and mouth, which can increase comfort and breathability. Additionally, attaching the filter at a distance from the user's mouth can lower the air pressure inside the respirator and thereby increase audibility. Further, the increased distance allows the user's voice to be more adequately projected and reduce distortion.

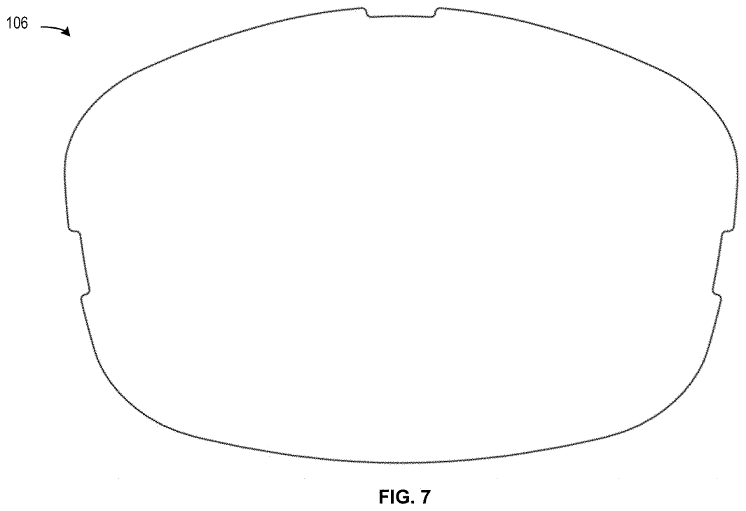

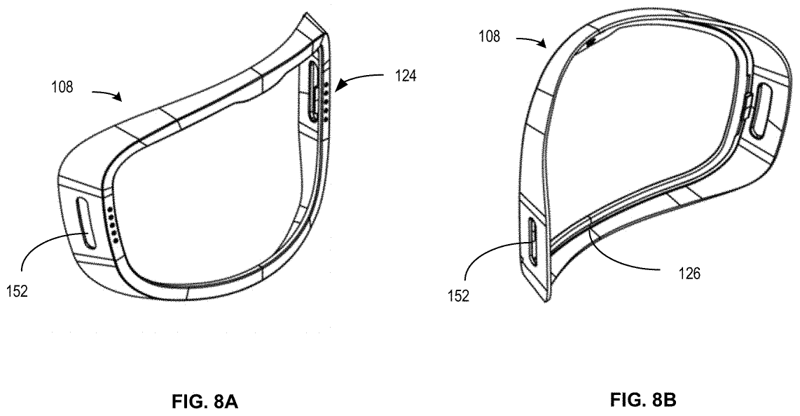

Referring now to FIG. 7, there is shown a front view of a filter 106 that may be used with respirator 100. The filter 106 is adapted to filter the air inhaled and exhaled by the wearer.

The filter 106 may be adapted to cover the entire surface of the frame opposite the face gasket and can extend generally vertically, preventing unfiltered air from passing through the frame. As shown in FIG. 7, the filter 106 may be substantially the same shape as the surface of the frame 104 opposite the face gasket 102 and be generally perpendicular to the opening of the user's mouth. By extending over the entire surface of the frame 104 opposite the gasket 102 and extending perpendicularly to the user's mouth, the filter 106 experiences a lower air pressure than traditional respirator filters which typically only cover a portion of the frame, forcing air and sound to pass through a small region, typically located on the side of the frame. The lower pressure achieved by the filter 106 covering the entire surface of the frame and creating a large filtering area can increase audibility, as the user's voice can pass through the filter which has a lower density than the frame, increase comfort, as the lower pressure can improve breathability, and increase the lifetime of the filter, as air is distributed over a larger filtering region.

In at least some embodiments, the filter 106 can be a disposable respiratory filter selectable and replaceable by the wearer. For example, based on the type of industry, situation or environment, different types of filtering medium may be required. In other embodiments, the filter may be ultrasonically fused to the frame 104 to form a filter-frame assembly. In such embodiments, the filtering medium and the frame 104 may be constructed of polypropylene to allow the two components to be securely connected and the filter-frame assembly instead of the filter alone, may be replaced.

The filter may be selected to meet filtering facepiece respirator (FFR) standards such as the N95, N99 or P100 standards, though it will be appreciated that other types of filters, depending on the setting may be used. The respirator 100 may be configured to adapt to filters having different thicknesses. For example, the respirator 100 may be capable of receiving filters having a thickness between about 0.7 mm and 1 mm. In at least some embodiments, more than one filter may be used. For example, multiple filters having a lower filtering efficiency may be stacked.

The filter 106 may include a warning line (not shown) that may alert the wearer that the filter is misplaced. For example, the filter 106 may be misplaced if the warning line is visible after installation. When the filter 106 is correctly positioned, the warning line is hidden by the filter compression ring and no gaps between the filter and the filter position ring are visible.

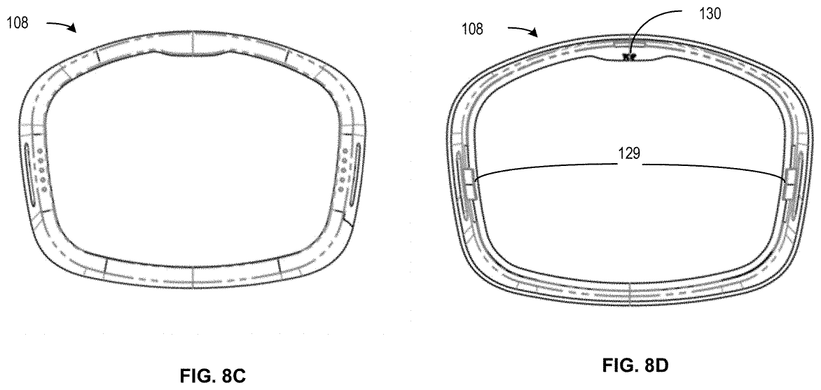

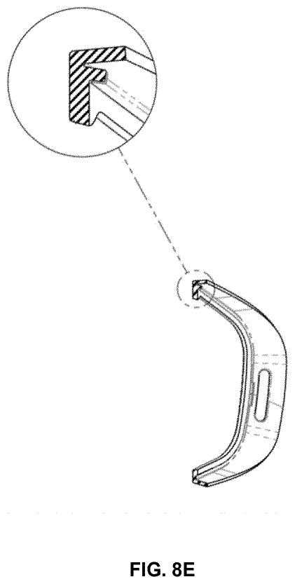

Referring now to FIGS. 8A-8E, there is shown a compression ring 108 that may be used with respirator 100. The compression ring 108 retains the filter in position over the frame 104 and may be removably attached to the frame. As shown in FIG. 8E, the filter compression ring 108 may include a ledge for securing the compression ring 108 to the frame 104.

In at least some embodiments, the filter compression ring 108 may include one or more filter locators 129 located on the interior surface of the ring to assist the user in positioning the filter. The filter locators may for example, be markings on the interior surface of the filter compression ring 108. Alternatively, or additionally, the filter locators may correspond to raised portions on the interior surface of the filter compression ring 108. In some embodiments, the filter compression ring 106 may additionally include one or more trapping cleats and/or one or more trapping notches 130 configured to retain the filter in place. As described above, two or more filters may also be used. The two or more filters may be stacked and trapped under the one or more trapping cleats and notches 129.

In at least one embodiment, the filter compression ring 108 may include a sealing ring 126. In some cases, the surface of the sealing ring 126 may include one or more retention pegs (not shown) to further secure the filter and prevent movement of the filter.

The compression ring 108 may include one or more apertures 152 located along the perimeter of the compression ring 106, configured to couple with the frame pegs 150 described above, with reference to FIGS. 4A-4B.

The outer surface of filter compression ring 108 can include raised portion(s) 124. The raised portion(s) 124 may be used to indicate where to apply force when attaching the filter compression ring 108 to the frame 104 and provide increased grip when applying pressure.

Referring now to FIG. 9, there is shown a diagram of a method 900 of installing a filter into the respirator. One or more steps may be optional, depending on the configuration of the respirator 100. At 902, the filter packaging may be removed. At 904, the filter may be inserted into the compression ring and may be aligned with the filter locators and/or the trapping cleats and notch. At 906, the filter compression ring containing the filter may be placed over the frame. The filter compression ring may be aligned with the frame by aligning a filter compression aperture over the corresponding frame peg. The filter compression ring and the frame may be coupled by pressing the filter compression ring against the frame. The coupling of the filter compression ring and the frame may be provided via a snap fit. At 908, the opposite side of the filter compression ring may be aligned with the frame by aligning the second filter compression ring aperture over the corresponding second frame peg. At 910 the second side of the filter compression ring may be attached to the frame by pushing the filter compression ring against the frame. FIG. 4A for example, shows the filter compression ring and the frame prior to installation and FIG. 4B shows the filter compression ring and the frame once attached.

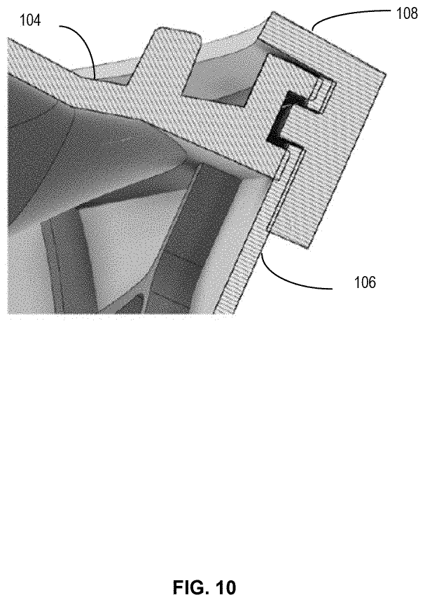

Referring now to FIG. 10, there is shown a closeup view of the frame 104, the filter 106 and the filter compression ring 108 once assembled. As shown, the filter compression ring 108 may extend over a front portion of the filter 106 and over a top portion of the frame 104 such that the filter 106 is pressed against the frame 104. As described above with reference to FIG. 7, more than one filter may be used. For example, multiple filters may be stacked and the filter compression ring 108 may compress these filters.

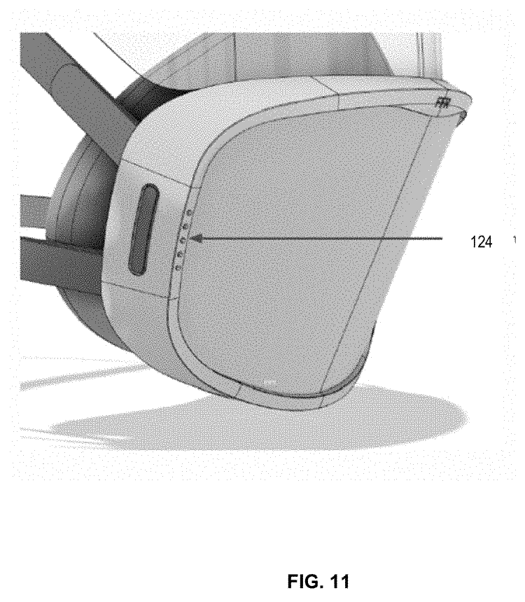

Referring now to FIG. 11, there is shown a closeup view of the respirator 100. In at least one embodiment, the outer surface of the filter compression ring may include a raised portion 124 that can indicate where to apply force when attaching the filter compression ring to the frame and providing increased grip when applying pressure.

Traditional masks are typically secured to a wearer's face using over-the-ear ear loops, which can interfere with prescription eyewear. Ear loops typically also have a fixed size, which may not be suitable for all types of faces, leaving gaps around the mask if the ear loop is too large or causing discomfort if the ear loop is too small.

Traditional respirators on the other hand, tend to be inadequately adjusted by the wearer and often overtightened, due to a perceived sense of protection, leading to pain and discomfort after prolonged use. Further, respirator users are typically fit tested only once a year, and therefore are unlikely to account for changes in hair volume, fluctuations in weight, or the integration of different or new types of personal protective equipment.

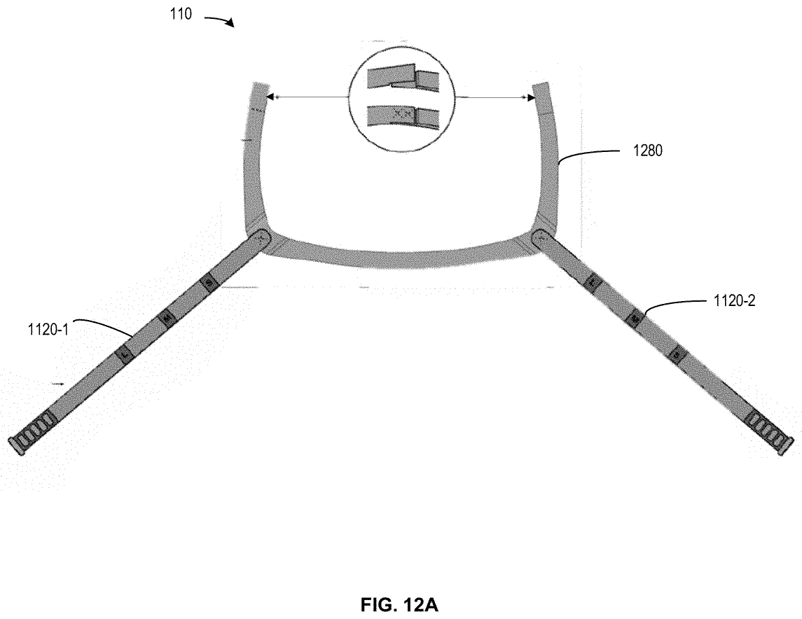

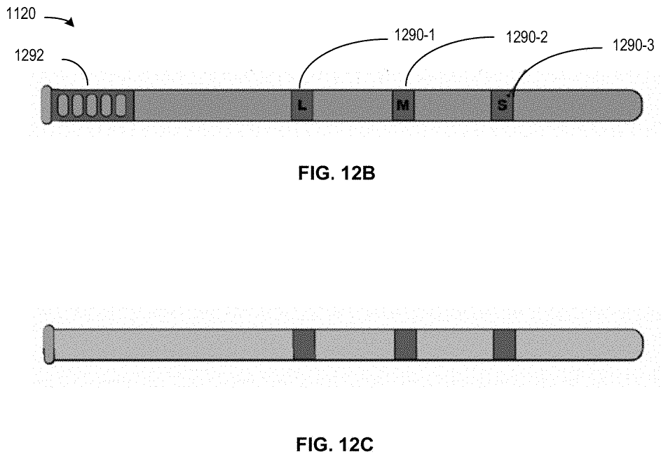

Referring now to FIGS. 12A-12C, there is shown an example head strap 110 that may be used with the respirator 100. In at least some embodiments, the respirator 100 includes at least one strap for securing the respirator to the wearer's face. The strap can extend from the frame and be adapted to be positioned behind the wearer's head.

For example, the head strap 110 may include a first strap branch 1120-1 and a second strap branch 1120-2 removably attached to the frame and adapted to be positioned along each side of the user's head and capable of being adjusted to the size of the user's head. For example, the first strap branch 1120-1 may pass through a slit in the frame (e.g., slit 103), and return onto itself for fastening, though it will be appreciated that any other suitable mechanism for attaching the head strap 1120 to the frame may be used. The surface of the head strap 110 may include a fastening portion 1292 allowing the strap to fasten onto itself, such as a hook and loop type fastener.

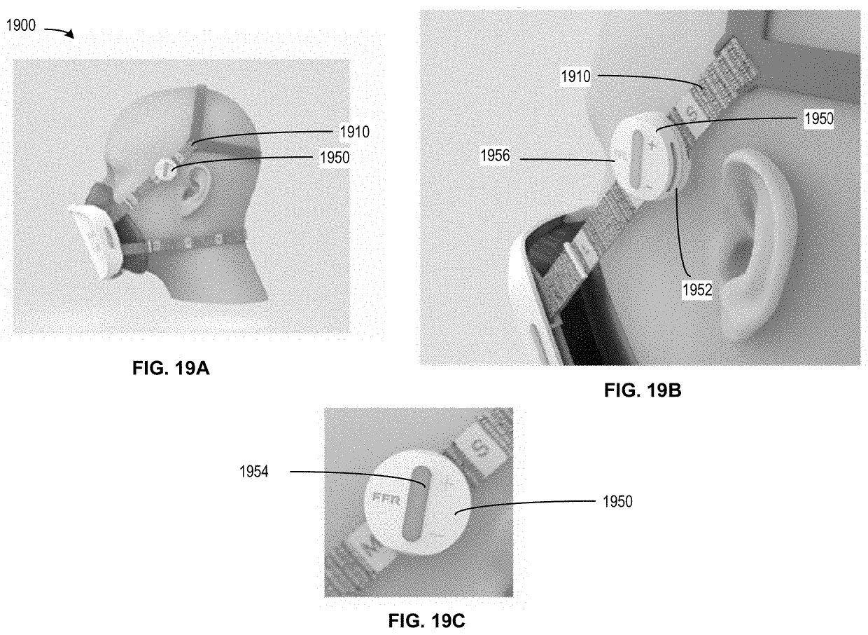

In some cases, the first strap branch 1120-1 and the second strap branch 1120-2 may terminate in a flexible skull cap 1280 adapted be positioned over the crown of the user's head as shown in the respirator of FIG. 19A. The skull cap 1280 may increase comfort by distributing the weight of the respirator over the crown of the user's head and more securely secure the respirator to the user's face by minimizing movement of the strap 110. The skull cap can be made of any flexible material, such as a flexible polyethylene, to adapt to variations in head size.

As shown in FIGS. 12B-12C, which show a front and a back view of a first strap branch 1120, the strap may include visual size markers 1290-1, 1290-2, 1290-3 placed on the outside surface of the strap. The visual markers may help the wearer obtain an appropriate fit or quickly adjust the strap according to the user's preferences. For example, the sizes may correspond to sizing standards established by the CSA, the National Institute for Occupational Safety & Health (NIOSH) and the American National Standards Institute (ANSI).

In some cases, the front and back of the strap may have different colors to facilitate attaching the strap to the frame and to allow the user to quickly identify the outside of the strap when donning the respirator if the strap becomes tangled or twisted, reducing donning time compared to traditional respirators.

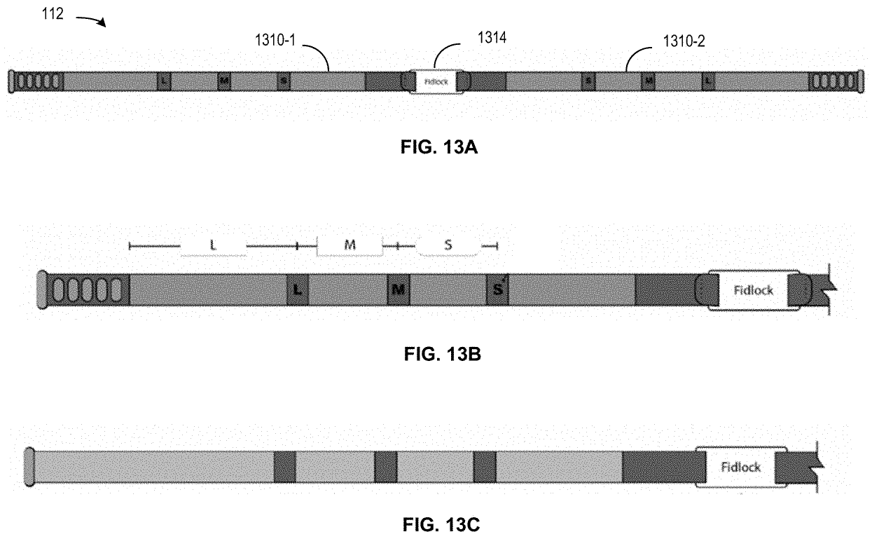

Referring now to FIGS. 13A-13C, there is shown a neck strap 112 that may be used with the respirator 100. The second strap may extend from the frame and be adapted to be positioned behind the wearer's neck as shown in the respirator of FIG. 19A. In some cases, the neck strap may include a first neck strap portion 1310-1 and a second neck strap portion 1310-2 and may include a fastener 1314 joining the first neck strap portion 1310-1 and the second neck strap portion 1310-2. The fastener 1314 can allow the wearer to quickly wear the respirator around their neck while adjusting the head strap over their head. For example, the fastener may be a push to open mechanical fastener. Alternatively, the fastener may be a magnetic quick release fastener.

Similar to the head strap 110 described above with reference to FIGS. 12A-12C, the neck strap 112 may include size markers. Similar to the head strap 110, the neck strap 112 may be removably attached to the frame of the respirator 100. For example, each extremity of the neck strap 112 may pass through a slit in the frame (e.g., slit 103) and return onto itself for fastening, though similar to the head strap 110, other fastening mechanisms may be used. Alternatively, in embodiments that include the fastener 1314, a first extremity of the first neck strap portion 1310-1 and a first extremity of the second neck strap portion 1310-2 may be fastened to the frame and the second extremity of the first neck strap portion 1310-1 and the second extremity of the second neck strap portion 1310-2 may be attached to the fastener 1314.

Similar to the head strap 110, as shown in FIGS. 13B-13C, the front and back of the neck strap 120 may be of different colors to facilitate attachment of the strap to the frame and to allow the user to quickly identify the outside of the strap when donning the respirator.

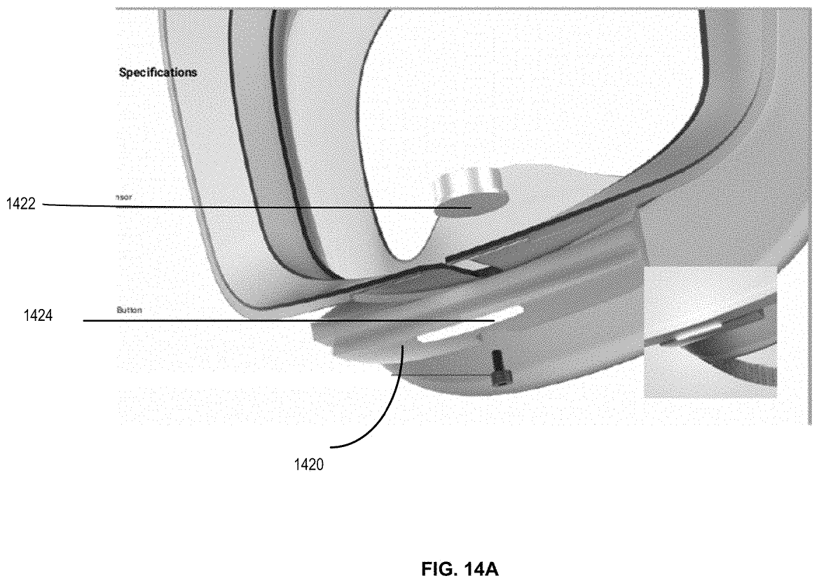

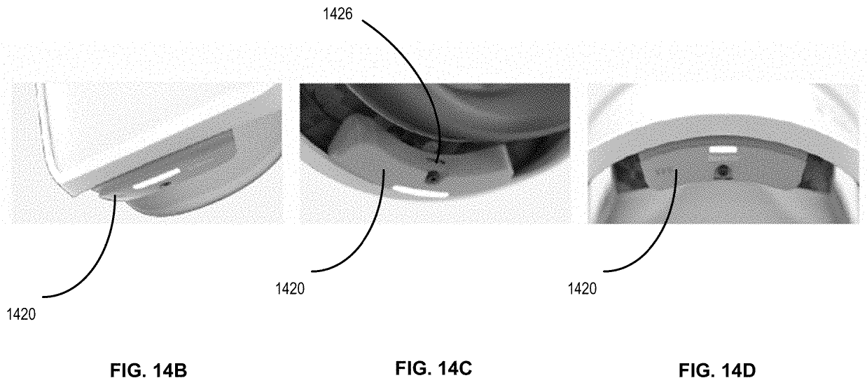

Referring now simultaneously to FIGS. 14A-14D, there is shown a closeup view of a safety module 1420 that may be removably mounted to respirator 100. For example, the safety module 1420 may be mounted to the respirator using a screw. The safety module 1420 may, for example, be mounted to a bottom surface of the frame of the respirator, substantially perpendicular to the filter. The safety module 1420 can include any combination of an air pressure sensor 1422, a motion detector such as an inertial measurement unit, a toxic compound detector, a vibration motor and a visual indicator, such as one or more lights. The one or more lights can for example, be multicolor LED lights. The safety module further includes a power button, a rechargeable battery for powering the components and a charging interface 1426 for recharging the battery and may include a communication interface that can transmit data to other devices via wireless communication. For example, the communication interface may include an NFC module and/or a Bluetooth module. The charging interface can for example, be a magnetic charging interface or a waterproof USB-C interface or any other type of water-resistant charging interface. In some cases, the light may be integrated with the power button. The safety module 1420 may additionally include one or more sensors for monitoring the health and fitness of the user. The components may be selected to generate little heat, to minimize discomfort. The safety module may be water resistant and may conform to water resistance standards such as IPX-7 and may be chemically resistant to sanitization products to avoid damage to the safety module.

Respirator users typically use analog methods for ensuring that a proper seal has been achieved, such as placing their hands over the respirator and rely on fit tests, which may only be performed once a year, to determine if their respirators are fitted. However, these traditional methods cannot account for incidents that may occur during the day that can result in the respirator being dislodged, potentially exposing the wearer to harmful airborne contaminants.

The safety module 1420 may be configured to alert the wearer and/or individuals around the wearer that an unsafe condition exists without the need to rely on analog methods. For example, the safety module 1420 may alert the wearer that the seal has been breached, that the filter requires changing and/or that the user has been exposed to a toxic compound.

The safety module can include one or more air pressure sensors 1422 located on an interior surface of the respirator frame. The air pressure sensor can be configured to monitor the air pressure in the space bounded by the filter and the wearer's mouth and nose area.

The air pressure sensor 1422 may be coupled to a processor configured to compare the air pressure measured by the air pressure sensor 1422 to a baseline air pressure corresponding to the air pressure when the seal between the respirator and the user's face is intact. The baseline air pressure can for example, be measured when the respirator is initially secured to the user's face. Alternatively, the baseline air pressure can be predetermined. The baseline air pressure may be stored in a memory coupled to the processor. If the air pressure measured by the air pressure sensor is determined to be inconsistent with the baseline, the wearer may be alerted through one or more mechanisms. For example, if the air pressure falls below a threshold, the processor may determine that the seal has been compromised and may cause the vibration motor to vibrate. Alternatively, or in addition thereto, the processor may cause the light 1424 to emit light. The light may be visible to other individuals around the wearer, for example, in a medical setting, the user's partner, who may indicate to the user that the visual indicator is emitting light. In some cases, the light emitted by the visual indicator may be visible to the user.

In addition to the fit issues associated with traditional respirators described above, respirator users are often unaware of the lifetime of a disposable filter and commonly dispose of filters prematurely, which may cause unnecessary waste. The safety module 1420 may allow the wearer to adequately determine when a filter requires changing.

For example, the at least one air pressure sensor 1422 may monitor the air pressure inside the respirator 100. As the filter absorbs contaminants and other particles, its filtering ability decreases and the air pressure inside the respirator increases. When the processor determines that the air pressure exceeds a predetermined threshold, indicating that the filter is at capacity, the wearer may be alerted that the filter requires changing. For example, the vibration motor of the safety module 1420 may vibrate. Alternately, the processor may cause the light 1424 to emit light that may be visible to users near the wearer and/or the wearer. In at least one embodiment, the visual indicator may provide an ongoing visual indication of the filter status. For example, the color of the light emitted by the visual indicator can be an indication of the filter status.

The vibration motor and the light may be configured to provide different vibration patterns and light colors or patterns to indicate different unsafe conditions. Additionally, the vibration motor and the light 1424 may be configured to remind the wearer of unsafe conditions if the wearer does not address the unsafe condition within a predetermined period of time. For example, the vibration motor may initiate a vibration sequence every five minutes following a breach of the seal until the seal is reestablished. Similarly, the light may initiate a flashing sequence every five minutes following a breach of the seal until the seal is reestablished.

In some embodiments, the light 1424 may also provide a visual indication of the battery status, a successful pairing with an external device, a confirmation of appropriate donning, and provide a warning of inadequate donning. For example, the light may flash intermittently to indicate a low battery and flash intermittently using another color as the battery is charged. A discharged battery may be unable to provide sufficient power to the safety module components to monitor air pressure and alert the user of unsafe conditions.

In at least one embodiment, when the user initially dons the respirator, the air pressure sensor 1422 may be configured to determine whether the user has adequately secured the respirator gasket to their face and whether the filter has been correctly installed. At least one of the visual indicator and the vibration motor may provide an indication to the user that the mask has been correctly donned. For example, the visual indicator may emit a green light when a seal has been established. For example, an incorrect placement of the filter may result in gaps, which may cause an abnormal air pressure. Similarly, an inadequate positioning of the face gasket may result in an inadequate seal, which may cause an abnormal air pressure. The safety module 1420 may be configured to detect these unsafe conditions and alert the user.

In at least one embodiment, to conserve battery power, the safety module 1420 may enter into sleep mode after a predetermined period of inactivity. The safety module 1420 may determine that the wearer has removed the respirator for an extended period of time. For example, the motion detector may monitor the user's motion. The motion detector may be coupled to a processor configurable to determine that based on the measurements obtained by the motion detector, the respirator has not moved during a predetermined period of time, indicating that the user has removed the respirator. The sleep mode may be indicated by a visual indicator. For example, the light may pulse a clear light when sleep mode has been entered.

In at least one embodiment, the safety module of the respirator may be coupled to an external device such as a mobile device, a tablet, a personal computer and/or a laptop computer, via the communication interface. The external device may be configured to record data relating to the use of the respirator. For example, the external device may record usage time, air pressure measurements, motion data and filter changes. In some cases, for example, the air pressure sensor may transmit air pressure measurements to the communication interface, which may transmit the measurements to the external device via wireless communication, such as an NFC or Bluetooth protocol. For example, the safety module may be configured to pair with the external device. In some cases, the light may provide a visual indicator that the safety module has been successfully paired.

The external device may be configured to perform air pressure calculations and transmit signals to the safety module 1420 to trigger the vibration motor and/or the light if an unsafe condition is detected.

The external device may operate an analysis system that can correlate air pressure measurements with timestamps and present this data to the user. For example, the user may be presented with a time at which the seal was compromised. Air pressure measurements coupled with time stamps may allow the wearer to identify the activity causing the breach and assess the severity and level of exposure that may have occurred based on the activity that was performed.

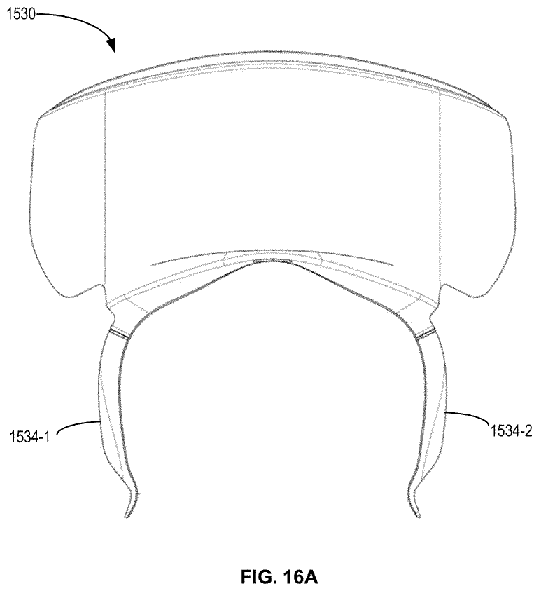

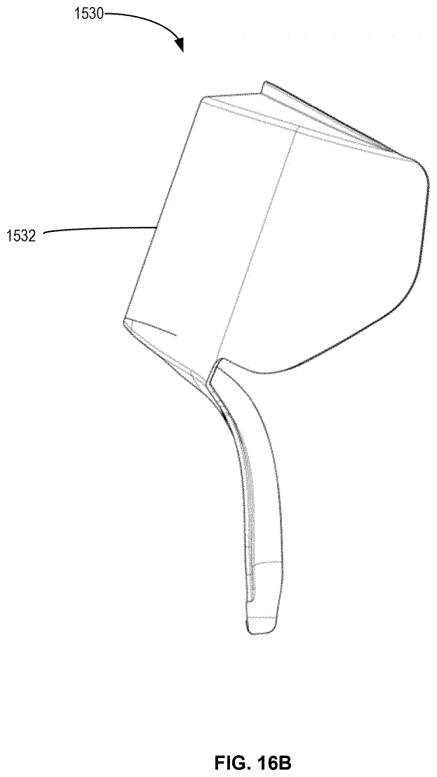

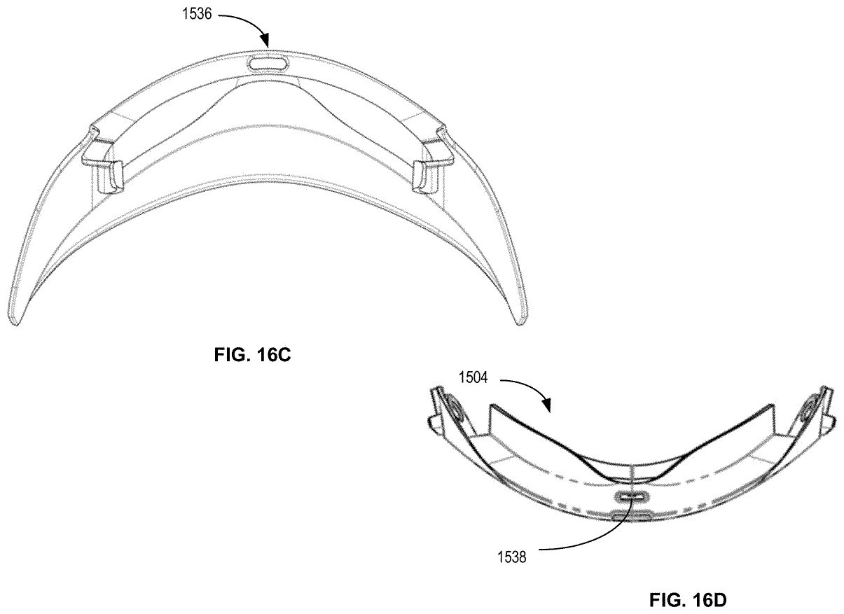

Referring now to FIGS. 15A-15E, there is shown an example respirator 1500. The respirator 1500 may be substantially similar to the respirator 100. Similar to respirator 100, the respirator 1500 may include a face gasket 1502, a frame 1504, a filter 1506, a filter compression ring 1508, a head strap 1510, a neck strap 1512 and a safety module 1514. Each of the face gasket 1502, the frame 1504, the filter 1506, the filter compression ring 1508, the head strap 1510 and the neck strap 1512 may be substantially similar to the corresponding components of respirator 100. However, the respirator 1500 may additionally include an eye protection accessory 1530. Referring simultaneously to FIGS. 16A-16C, the eye protection accessory 1530 can include a lens 1532 and two arms 1534-1, 1534-2 extending from a lower portion of the lens 1532. The lens 1532 may be curved and/or include wings to provide a wraparound coverage of the upper half face and eyes of the wearer and may match the curvature of the frame 1504 of the respirator 1500 to provide proper alignment with the respirator 1500.

Traditional protective eyewear is typically designed for standalone use, without a respirator or mask. Traditional protective eyewear on the other hand is typically not adapted for users who require prescription eyeglasses. The use of protective eyewear in conjunction with prescription eyeglasses can therefore cause the user's prescription eyeglasses to be pressed against the user's face and may interfere with the arms of the prescription eyeglasses, which may cause discomfort or cause the protective eyewear to be inadequately positioned.

The respirator 1500 is configured to allow a user to wear prescription eyeglasses by providing an eye protection accessory 1530 that may be removably attached to the respirator 1500. For example, the arms 1534-1, 1534-2 of the eye protection accessory 1530 may wrap around an exterior surface of the face gasket 1502 near the frame 1504 such that the lens 1532 of the eye protection accessory 1530 extends above the frame 1504 of the respirator 1500. By extending over the frame 1504, the lens 1532 is positioned at a distance from the user's face, which can allow the user to wear prescription eyeglasses without interfering with the eye protection accessory 1530 and reduce lens fogging. For example, the lens 1532 may be positioned at a distance of around 40 mm away from the user's face.

The arms 1534-1, 1534-2 may be adapted to wrap around the face gasket 1502 such that there is no visible or a minimal gap between the arms 1534-1, 1534-2 and the face gasket 1502. In some cases, to further secure the eye protection accessory 1530 to the respirator, the arms 1534-1, 1534-2 may be secured to the respirator 1500 via one or more attachments located on each side of an interior surface of the frame 1504. For example, the frame 1504 may include one or more wishbone-type connectors.

The lens 1532 can be made of any material suitable with a sufficient transparency to provide the user with a clear field of vision, for example, optical grade polycarbonate, and can be any color. For example, a clear lens may be optimal at nighttime or for indoor use, while a high contrast yellow lens may be preferable for low-light conditions, hazy, or cloudy conditions. A smoked lens may be preferable for outdoor use or bright conditions and a high contrast vermillion lens may be preferable in conditions that require enhanced color recognition, depth perception or glare reduction. The lens 1632 may also be made using materials that provide additional features such as ballistic protection, fog reduction or laser protection and may meet eye protection standards defined by agencies and organizations such as the CSA, the American National Standards Institutes (ANSI), the International Safety Equipment Association (ISEA) and the United States military.

As shown in FIG. 16C, the underside surface of the lens 1532 may additionally include an aperture 1536 adapted to couple to an attachment point such as a peg on the top surface of the frame 1504 to prevent horizontal movement of the eye protection member 1600, as shown by peg 1570 in FIG. 16D.

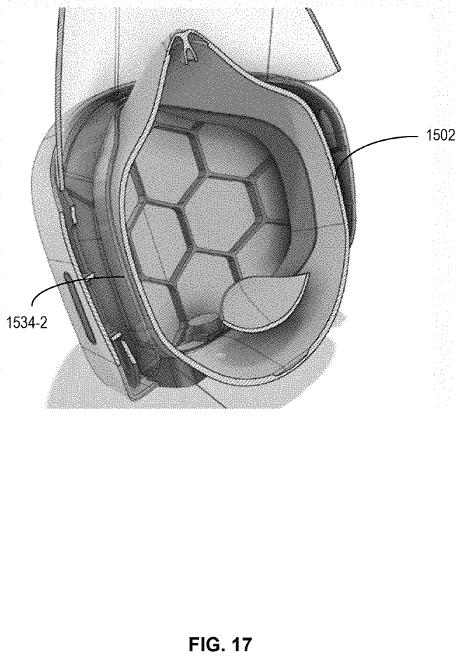

Referring now to FIG. 17, there is a cross-sectional view of the respirator 1500 shown in FIG. 15A showing the attachment mechanisms described above with reference to FIGS. 15A-15E and FIGS. 16C-16D. As shown in FIG. 17, the arms 1534-2 (1534-1 not visible) may wrap around the face gasket 1502.

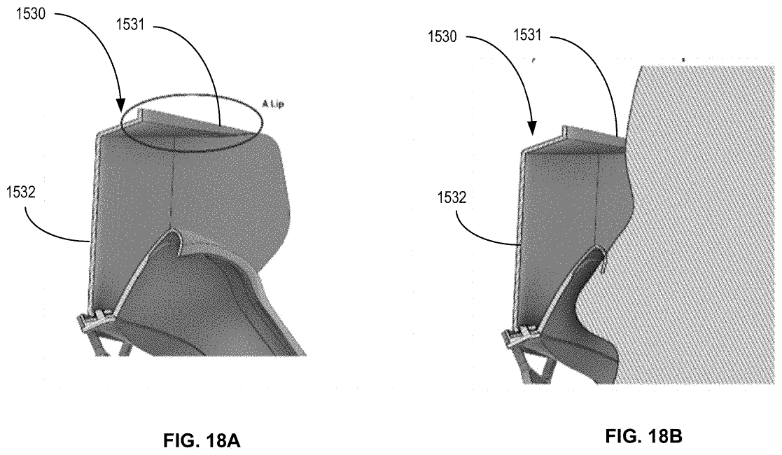

Referring now to FIGS. 18A-18B, there is shown a closeup cross-sectional view of a portion of the respirator 1500. In at least one embodiment, the upper portion of the eye protection accessory 1530 may include a lip 1531 to minimize impact forces on the user's face if the lens of the eye protection accessory 1530 is struck. FIG. 18B for example shows the eye protection 1530 worn by a user, showing the space between the wearer's eye and the lens 1532 as described above, allowing the wearer to wear eyeglasses without pressing the eyeglasses against the wearer's face.

Referring now to FIGS. 19A-19C, there is shown an example respirator 1900. The respirator 1900 may be substantially similar to respirators 100 and 1500 and may similarly include a face gasket, a frame, a filter, a filter compression ring, a head strap, a neck strap and a safety module. However, respirator 1900 may additionally include a communications module 1950. The communications module may be removably attached to a strap of the respirator. For example, the communications module may be attached to the head strap 1910 of the respirator and be positioned near the ear of the wearer.

Respirator wearers such as paramedics regularly communicate via handheld radio microphones to hospitals and dispatchers. Paramedics typically also work with a partner, requiring constant communication with the partner. Traditional respirators however have a low audibility, resulting in audio communications that may be unclear.

The communications module 1950 may include one or more speakers 1952, a microphone 1956, a battery for powering the components (not shown), a charging port for recharging the battery (not shown), a processor (not shown), a communication interface for wireless communication (not shown), a volume button 1954, and one or both of a motion detector such as an inertial measurement unit (not shown), and a status light (not shown), which may be a multicolor LED light. The battery may be any type of rechargeable battery capable of providing sufficient power to the communications module, for example, a CR2032 battery. The charging port can for example be a waterproof USB-C port. In some cases, the light may be integrated with the power button. The communications module may be water resistant and may conform to water resistance standards such as IPX-7 and be chemically resistant to sanitization products to avoid damage to the module.

The status light may for example, provide a visual indicator that the battery is low and requires charging.

In at least one embodiment, the communications module 1950 may communicate with the safety module, for example, to provide auditory alerts to the user. For example, the one or more speakers 1952 may notify the user that the filter requires changing, that a seal has been achieved, or that the seal has been compromised. In at least one embodiment, the safety module and the communications module 1950 may communicate wirelessly.

In at least one embodiment, the communication interface may be configured to transmit data to other devices via wireless communication. For example, the communication interface may be configured to communicate wirelessly over a Wi-Fi network and or using a Bluetooth protocol. The communication interface may allow the wearer to communicate via a local wireless network with hospitals, dispatchers or their partner using the microphone. The one or more speakers can be configured to fire directional audio toward the ear of the user. Using directional speakers allows in-ear earphones or over-the-ear headphones to be avoided, increasing comfort, and allowing the wearer to maintain the ability to hear ambient sounds, increasing situational awareness.

In at least one embodiment, the communications module further includes a processor capable of performing voice recognition, allowing the wearer to trigger functions, such as setting the volume or initiating communication via the local wireless network without manual intervention. Alternatively, or in addition thereto, the communications module may be pairable with an external device such as a mobile device and allow the wearer to trigger cellular communications.

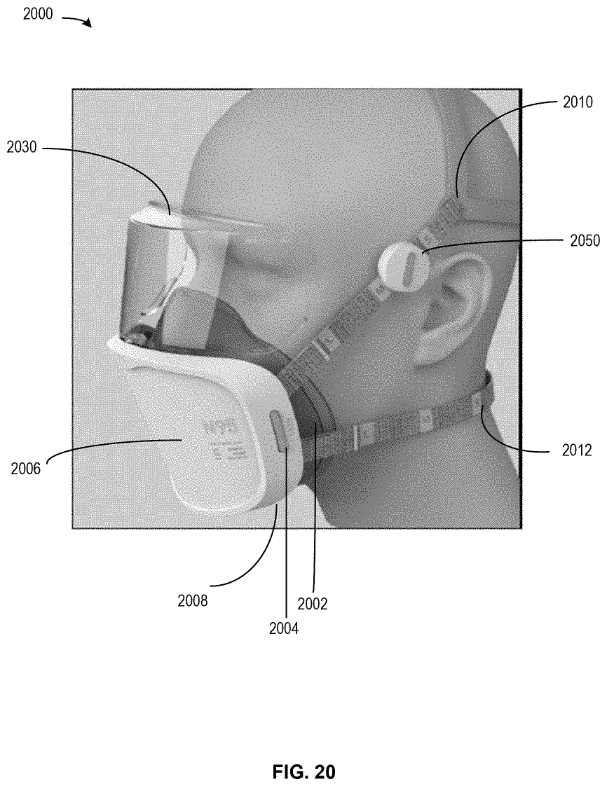

Referring now to FIG. 20, there is shown another example respirator 2000 in accordance with an embodiment. Similar to the example respirator 100 shown in FIGS. 1A-1D, to the example respirator 1500 shown in FIGS. 15A-15E and to the example respirator 1900 shown in FIGS. 19A-19C, the respirator 2000 may include a face gasket 2002, a frame 2004, a filter 2006, a compression ring 2008, a head strap 2010, a neck strap 2012 and a safety module (not shown). Similar to the example respirator 1500, the respirator 2000 may include an eye protection accessory 2030. Similar to the example respirator 1900, the respirator 2000 may include a communications module 2050. The respirator 2000 may be substantially similar to respirators 100, 1500 and 1900 but may include all the features of these respirators. In particular, respirator 2000 may include all of the features of respirator 100, all of the features of respirator 1500 and all of the features of respirator 1900.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A respirator for protecting against airborne particles, the respirator comprising:
a face gasket for providing a seal around a mouth and a nose of a wearer;
a frame attached to the face gasket;
a filter compression ring removably attached to the frame; and
a filter for filtering airborne particles from air, wherein the filter is positioned between the frame and the filter compression ring, generally perpendicular to the mouth of the wearer.

2. The respirator of claim 1, wherein the filter is adapted to cover a surface of the frame opposite the face gasket.

3. The respirator of claim 2, wherein the frame comprises a filter support for supporting the filter over the frame and for maintaining a shape of the filter.

4. The respirator of claim 3, wherein the filter is removably attached to the filter compression ring.

5. The respirator of claim 1, wherein the filter is fused to the frame.

6. The respirator of claim 5, wherein the filter is ultrasonically fused to the frame.

7. The respirator of claim 1, further comprising a safety module, the safety module comprising:
one or more air pressure sensors for obtaining air pressure measurements in a space bounded by the nose and the mouth of the wearer and the filter;
a processor in communication with the one or more air pressure sensors, the processor configured to analyze the air pressure measurements; and
at least one of a vibration motor and a status indicator.

8. The respirator of claim 7, wherein the processor is further configured to:
determine a baseline air pressure;
determine a current air pressure; and
when the current air pressure exceeds the baseline air pressure by a predetermined threshold,
trigger the at least one of the vibration motor or the visual indicator to generate an alert.

9. The respirator of claim 8, wherein the safety module further comprises a motion sensor coupled to the processor, wherein the processor is configured to analyze motion measurements obtained by the motion sensor.

10. The respirator of claim 9, wherein the safety module further comprises a communication interface configured to transmit the air pressure measurements to an external device for analysis.

11. The respirator of claim 1, wherein the face gasket is configured to be positioned to terminate at a nose bridge of the wearer.

12. The respirator of claim 2, further comprising:
a first strap removably attached to the frame and a second strap removably attached to the frame, the first strap and second strap configured to secure the respirator to the wearer,
wherein the first strap is configured to wrap behind a head of the wearer and
the second strap is configured to wrap behind a neck of the wearer.

13. The respirator of claim 12 wherein a length of the first strap and a length of the second strap are adjustable.

14. The respirator of claim 12, wherein the second strap comprises a first portion and a second portion, and wherein the first portion is configured to attach to the second portion via a fastener.

15. The respirator of claim 12 wherein the first strap comprises a skull cap configured to be positioned on a crown of the head of the user.

16. A respirator for protecting against airborne particles, the respirator comprising:
a face gasket for providing a seal around a mouth and a nose of a wearer;
a frame attached to the face gasket;
a filter compression ring removably attached to the frame;
a filter for filtering airborne particles from air, wherein the filter is positioned between the filter compression ring and the frame and generally perpendicular to the mouth of the wearer; and
an eye protection removably attached to an outside surface of the face gasket and extending above the frame.

17. The respirator of claim 16, wherein the eye protection is configured to wrap around a face of the wearer.

18. The respirator of claim 17, wherein the eye protection includes a lip substantially perpendicular to eyes of the wearer.

19. The respirator of claim 18, wherein the eye protection comprises a first branch, a second branch and a lens, wherein the first branch and the second branch are adapted to wrap around the outside surface of the face gasket and wherein the lens extends above the frame.

20. The respirator of claim 19, wherein an underside of the lens comprises an aperture, the frame comprises a peg and wherein the peg is adapted to couple to the aperture to attach the lens to the frame.

21. The respirator of claim 17, wherein the filter is fused to the frame.

22. The respirator of claim 21, wherein the filter is ultrasonically fused to the frame.

23. The respirator of claim 17, further comprising a safety module, the safety module comprising:
one or more air pressure sensors for obtaining air pressure measurements in a space bounded by the nose and the mouth of the user and the filter;
a processor in communication with the one or more air pressure sensors, the processor configured to analyze the air pressure measurements; and
at least one of a vibration motor or a status indicator.

24. The respirator of claim 23, wherein the processor is further configured to:
determine a baseline air pressure;
determine a current air pressure; and
when the current air pressure exceeds the baseline air pressure by a predetermined threshold,
trigger the at least one of the vibration motor or the visual indicator to generate an alert.

25. The respirator of claim 24, wherein the safety module further comprises a motion sensor coupled to the processor, wherein the processor is configured to analyze motion measurements obtained by the motion sensor.

26. The respirator of claim 25, wherein the safety module further comprises a communication interface configured to transmit the air pressure measurements to an external device for analysis.

27. The respirator of claim 17, wherein the face gasket is configured to be positioned to terminate at a nose bridge of the wearer.

28. The respirator of claim 17, further comprising:
a first strap removably attached to the frame and a second strap removably attached to the frame, the first strap and second strap configured to secure the respirator to the wearer,
wherein the first strap is configured to wrap behind a head of the wearer, and
the second strap is configured to wrap behind a neck of the wearer.

29. The respirator of claim 28 wherein a length of the first strap and a length of the second strap are adjustable.

30. The respirator of claim 29, wherein the second strap comprises a first portion and a second portion, and wherein the first portion is configured to attach to the second portion via a fastener.

31. The respirator of claim 30, wherein the first strap comprises a skull cap configured to be positioned on a crown of the head of the user.

32. A respirator for protecting against airborne particles, the respirator comprising:
a face gasket for providing a seal around a mouth and a nose of a wearer;
a frame attached to the face gasket;
a filter compression ring removably attached to the frame;
a filter for filtering airborne particles from air, wherein the filter is suspended between the filter compression ring and the frame, generally perpendicular to the mouth of the wearer; and
a communications module configured to communicate with an external device.

33. The respirator of claim 32, wherein the communications module comprises:
one or more speakers;
a microphone; and
a communication interface;

34. The respirator of claim 33 wherein the communications module further comprises:
a motion sensor; and
a status light.

35. The respirator of claim 32, wherein the respirator further comprises an eye protection removably attached to an outside surface of the face gasket and extending above the frame.

36. The respirator of claim 32, further comprising:
a first strap removably attached to the frame, the first strap configured to wrap behind a head of the user,
wherein the communications module is removably mounted onto the first strap, adjacent to an ear of the user.
